(19) United States
(12) Patent Application Publication
(10) Pub. No.: US 2024/0047718 A1
(43) Pub. Date: Feb. 8, 2024

(54) METHOD FOR ESTABLISHING THE DEGRADATION OF A HUMIDIFIER

(71) Applicant: MAHLE International GmbH, Stuttgart (DE)

(72) Inventor: Markus Auer, Stuttgart (DE)

(21) Appl. No.: 18/229,158

(22) Filed: Aug. 1, 2023

(30) Foreign Application Priority Data
Aug. 2, 2022 (DE) 10 2022 207 984.1

(51) Int. Cl. H01M 8/04664; H01M 8/04119; H01M 8/04492; H01M 8/04029; H01M 8/04701; H01M 8/04828; H01M 8/04746; H01M 8/04537

(52) U.S. Cl. CPC H01M 8/04679; H01M 8/04149; H01M 8/04507; H01M 8/04029; H01M 8/04723; H01M 8/04835; H01M 8/04753; H01M 8/04559

(57) ABSTRACT

The invention relates to a method (5) for establishing the degradation of a humidifier (4) of a fuel cell system (1) having a fuel cell stack (2) and the humidifier (4). The fuel cell stack (2) comprises multiple fuel cells (3) with cathodes.

In the method:
a starting parameter of the fuel cell stack (2) is determined in a step A;
based on the starting parameter, a humidification of the cathodes is evaluated in a step B;
in the case that the humidification of the cathodes is too low, a control parameter is determined and a control variable correspondingly readjusted in a step C;
a diagnostic parameter is determined in a step D and based on the diagnostic parameter, the degradation of the humidifier (4) established.

The invention also relates to the fuel cell system (1) for carrying out the method (5).

### CROSS-REFERENCE TO RELATED APPLICATION

This application claims priority to German Patent Application No. DE 10 2022 207 984.1 filed on Aug. 2, 2022, the contents of which are hereby incorporated by reference in its entirety.

### TECHNICAL FILED

The invention relates to a method for establishing the degradation of a humidifier of a fuel cell system. The invention also relates to the fuel cell system for carrying out the method.

### BACKGROUND

A fuel cell system includes at least one fuel cell stack having multiple fuel cells and a humidifier is employed in the fuel cell system for humidifying cathodes of the fuel cells. During its lifespan, the humidifier becomes increasingly less efficient and increasingly transmits less steam from the humid side to the dry side. The aging of the humidifier depends not only on the operating hours of the humidifier but also on external influences. The external influences can be for example operating the humidifier at high temperatures, an extended stoppage of the humidifier in the dry state, a poisoning of the humidifier by harmful gases or by liquids such as oil or by solids such as dust or rust. The inefficiency of the humidifier results in a low humidity of cathodes of the fuel cells of the fuel cell stack. Because of this, hot spots can form on membranes of the fuel cells which result in pinholes and because of this in the mixing of H2 and air on the membranes. Because of the reduced humidification of the cathode, the resistance of the membranes increases and the efficiency of the fuel cells decreases. Accordingly, the performance and the lifespan of the fuel cell stack also decreases. For this reason, it is desirable to determine as accurately as possible the end of the practical utilisation period of the humidifier.

### SUMMARY

The object of the invention therefore is to state for a method for establishing the functionality or the degradation of a humidifier of a fuel cell system an improved or at least alternative embodiment, with which the described disadvantages are overcome. The object of the invention also is to provide a corresponding fuel cell system for carrying out the method.

According to the invention, these objects are solved through the subject of the independent claim(s). Advantageous embodiments are subject of the dependent claims.

The present invention is based on the general idea of determining, for establishing the degradation of a humidifier of a fuel cell system, a voltage response of the fuel cell stack or a further parameter and from this determine the extent to which the water transfer performance of the humidifier is degraded.

The method according to the invention is provided for establishing the degradation of a humidifier of a fuel cell system. Besides the humidifier, the fuel cell system also comprises at least one fuel cell stack having multiple fuel cells. Each of the fuel cells comprises a cathode and an anode and the humidifier is designed for humidifying the cathodes of the multiple fuel cells. In the method, the steps A, B, C, D are carried out consecutively. In the step A, a starting parameter of the fuel cell stack is initially determined and in the step B a humidification of the cathodes of the multiple fuel cells evaluated based on the determined starting parameter. In the step C, in the case that humidification of the cathodes of the multiple fuel cells is too low, a control parameter for readjusting the humidifier is determined and a control variable readjusted according to the control parameter. In the step D, a diagnostic parameter is then determined and the degradation of the humidifier established based on the diagnostic parameter.

In the steps A-C of the method, the humidifier can be readjusted and because of this the lacking humidification of the cathodes of the fuel cells because of the progressive aging of the humidifier, compensated for. The lacking humidification of the cathodes of the fuel cells generally results in the lowering of the relative humidity on the fuel cells and because of this in the lowering of the efficiency of the fuel cell stack. The excessive increasing of the water quantity on the cathodes results in that gas channels on the cathodes are partially blocked and the resistance of membranes of the fuel cells reduced. Because of this, a higher efficiency of the fuel cells and thereby of the fuel cell stack can be achieved. In the step D of the method it can be additionally established when the lacking humidification of the cathodes of the fuel cells can no longer be compensated by readjusting the humidifier. From this, the time when the humidifier has to be replaced can be finally derived.

The term “variable” here and further is to mean a measurable characteristic of a state or of a component of the fuel cell system. The term “parameter” refers to a value of the corresponding variable. The “readjusting of the humidifier” generally means an adjustment of the fuel cell system which results in increased humidification or increased relative humidity of the cathodes of the fuel cells.

The starting parameter determined in the step A can be for example a relative humidity at the inlet of the cathode of the fuel cell stack. The relative humidity of the gas flowing into the cathode of the fuel cell stack can be measured on the fuel cell stack on the inlet side. Based on the measured value of the relative humidity it can be determined, for example by means of a comparison with a predefined set-point value of the relative humidity, whether the humidification of the cathodes of the fuel cells is adequate or lacking.

The term “degradation of the humidifier” primarily means the degradation of a membrane stack of the humidifier and/or membranes stacked to one another of the membrane stack of the humidifier. The degradation of the humidifier and/or of the membrane stack of the humidifier and/or of the membranes stacked against one another of the membrane stack of the humidifier can be caused in particular through the external influences—for example an operation of the humidifier at high temperatures, a long stoppage of the humidifier in the dry state, a poisoning of the humidifier by harmful gases or by liquids such as oil or by solids such as dust or rust. In the method, the degradation of the humidifier and/or of the membrane stack of the humidifier and/or of the membranes stacked against one another of the membrane stack of the humidifier as such can be determined in particular. The degradation of the humidifier can be determined as a continuous function. In other words, the magnitude or the extent of the degradation of the humidifier and/or of the membrane stack of the humidifier and/or of the membranes stacked against one another of the membrane stack of the humidifier can be determined.

In a first embodiment of the method it can be provided that the fuel cell system comprises a cooling system that can be flowed through by a cooling liquid for cooling the fuel cell stack. The control parameter determined in the step C for readjusting the humidifier can be specified by a temperature of the cooling liquid that is re-adjustable by means of the cooling system. The cooling system can comprise a heat exchanger and/or or a blower for cooling the cooling liquid. In the step C, the cooling capacity of the cooling system for readjusting the humidification can then be increased by readjusting the flow through the heat exchanger and/or by readjusting the blower. Thus, in the case that the humidification of the cathodes of the multiple fuel cells is too low, the humidification of the cathodes can be increased in that the temperature of the cooling liquid is lowered. The further operating conditions can remain the same. The lowering of the temperature of the cooling liquid can be achieved by the greater flow through the heat exchanger and/or by a higher rotational speed of the blower. The first embodiment of the method can be used in particular with a humidifier which does not make possible readjusting the capacity.

Alternatively to the first embodiment of the method, the humidifier can comprise on the inlet side and on the dry air side a bypass having a bypass valve for flowing past the humidifier. The control parameter for readjusting the humidifier determined in the step C can then be specified by a closed/open position of the bypass valve of the bypass. It is to be understood that the bypass valve can comprise multiple closing/opening positions deviating from one another and because of this the bypass can be opened/closed by a different degree. The readjusting in the step C can be realised for example by a greater degree of closing the bypass valve. When the bypass is closed to a greater degree than before, a higher air volume flows via the humidifier and a lower air volume via the bypass. Accordingly, a higher air volume is humidified in the humidifier and the relative humidity of the entire air volume increases. Accordingly, the cathodes of the fuel cells are humidified to a greater degree. The closing/opening position of the bypass valve readjusted in the step C can then become the standard setting of the bypass valve.

The bypass with the bypass valve can be employed in particular in the fuel cell system in which the humidifier is designed for low load points of the fuel cells or of the fuel cell stack. At higher load points or higher loads of the fuel cell stack, the bypass, for a degree of humidification that is comparatively identical or for a similarly high water charge of the gas at the inlet of the fuel cells, is opened to a greater degree than at low load points or low loads of the fuel cell stack. In order to increase the water volume on the cathodes, the bypass can be closed to a greater degree at high load points or high loads of the fuel cell stack. It is to be understood that the opening/closing of the bypass takes place by changing the closing/opening position of the bypass valve.

In a second embodiment of the method, the diagnostic parameter determined in the step D can then be specified by a temporal change of the closing/opening position of the bypass valve over the lifespan of the humidifier compared with a predefined control characteristic map of the bypass valve. The degradation of the humidifier can then be established based on the determined temporal change of the closing/opening position of the bypass valve. In other words, the degradation of the humidifier can be established by way of the creeping change of the closing/opening position or the standard settings of the bypass valves compared with the predefined control characteristic map. The second embodiment of the method can be used in particular with the regulated bypass valve and/or the regulated humidifier.

In a third embodiment of the method, the diagnostic parameter determined in the step D can be specified by a change of a voltage in a voltage/current characteristic of the fuel cell stack when readjusting the control variable in the step C. In other words, the voltage/current characteristics of the fuel cell stack before and after the readjusting of the control variable in the step C can be measured and compared with one another. By way of the change of the voltages of the fuel cell stack it can then be established if the humidifying of the cathodes of the multiple fuel cells is increased or not increased by the change of the control variable in the step C. For example, the bypass valve can be briefly closed further for this purpose and the voltage/current characteristics of the fuel cell stack before and after the closing of the bypass valve, determined. By way of the measured voltage/current characteristics of the fuel cell stack the degradation of the humidifier can then be established.

When establishing the degradation, the voltages measured before and after the readjusting of the control variable in the step C can be compared with one another. When the measured voltage rises after the readjusting of the control variable in the step C at least at one specified current value, the degradation of the humidifier can then be evaluated. In doing so, the voltages at a single specified current value or at multiple specified current values or however the entire voltage/current characteristics can be compared with one another.

When the humidification of the cathodes is increased, the relative humidity on the cathodes and thus also the voltage on the fuel cell stack rise accordingly. By readjusting the control variable in the step C, the humidification of the cathodes and the voltage on the fuel cell stack also rise accordingly with the non-degraded humidifier. When, by contrast, the humidifier is degraded, the humidification of the cathodes is not increased to a comparatively great degree and the voltage on the fuel cell stack accordingly does not rise to a comparatively equal degree by the readjusting of the control variable in the step C.

The voltage can be determined by means of a terminal voltage measurement on the fuel cell stack. Alternatively, the voltage can be read out from an integrated control unit of the fuel cell stack.

The voltage degradation on the fuel cell stack cannot be exclusively caused by the degradation of the humidifier. Accordingly, the voltage can also be dependent on the degradation of the fuel cells or by reversible effects, such as for example by the accumulation of CO on anodes of the fuel cells. In order to exclude the abovementioned factors, further measures when determining the voltage on the fuel cell stack can be provided. Accordingly, when determining the voltage, it is possible to run up to a specified stationary operating point of the fuel cell system. It is conceivable that an available degradation model of the fuel cell stack is taken into account when establishing the degradation. The degradation model of the fuel cells can reflect an expected voltage/current characteristic taking into account the ageing of the fuel cells. When establishing the degradation, the voltage/current characteristic measured after the readjusting of the control variable in the step C can be additionally compared with the expected voltage/current characteristic mentioned above. When the voltage/current characteristics correspond, there is no degradation of the humidifier. When the voltage/current characteristic measured after the readjusting of the control variable in the step C is below the expected voltage/current characteristic, the humidifier is degraded. It is also conceivable that prior to determining the voltage a specified O2/O2 condition and/or a specified H2/H2 condition on anodes and cathodes of the fuel cells of the fuel cell stack are ensured.

The third embodiment of the method can be employed in particular when the fuel cell system cannot continuously measure the relative humidity at the inlet of the cathodes of the fuel cell stack and/or does not comprise a regulated bypass valve and/or does not comprise a regulated humidifier.

The invention also relates to a fuel cell system having at least one fuel cell stacks with multiple fuel cells and having a humidifier. The fuel cells comprise in each case a cathode and an anode and the humidifier is designed for humidifying the cathodes of the multiple fuel cells. The fuel cell system is designed for carrying out the method described above. In order to avoid repetitions, reference is made at this point to the above explanations.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 a schematic view of a fuel cell system according to the invention;

FIG. 2 a schematic embodiment diagram of a method according to the invention.

### DETAILED DESCRIPTION

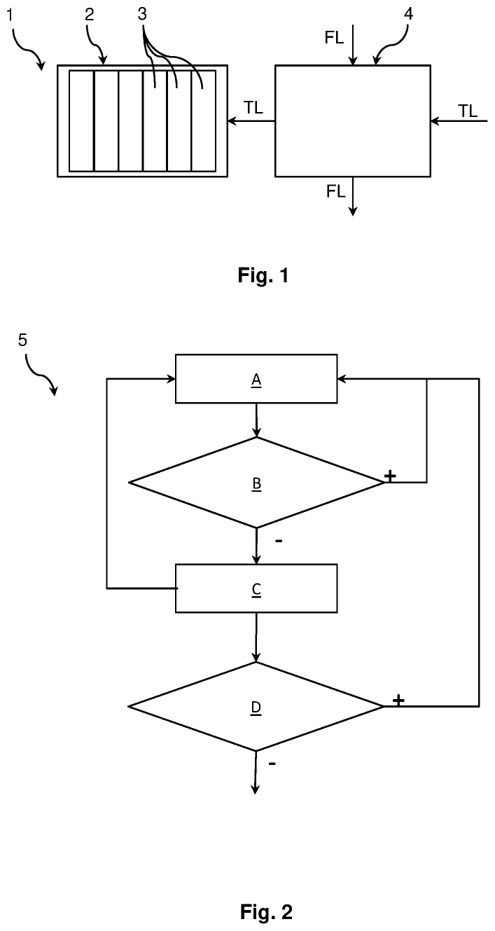

FIG. 1 shows a schematic view of a fuel cell system 1 according to the invention. The fuel cell system 1 comprises a fuel cell stack 2 having multiple fuel cells 3 and a humidifier 4. The fuel cell system 1, the fuel cell stack 2, the fuel cells 3 and the humidifier 4 can be constructed in a manner known to the person skilled in the art. The humidifier 4 is provided for humidifying cathodes—not shown here—of the multiple fuel cells 3. The humidifier 4 is flowed through by a dry air TL and a humid air FL. In the humidifier 4, the dry air TL is humidified by the humid air FL and flows onto the fuel cell stack 2.

FIG. 2 shows a schematic embodiment diagram of a method 5 according to the invention for establishing the degradation of the humidifier 4 of the fuel cell system 1 in FIG. 1. The fuel cell system 1 in FIG. 1 is designed for carrying out the method 5.

In the method 5, steps A, B, C, D are consecutively carried out. In the step A, a starting parameter of the fuel cell stack 2 is first determined and in the step B, a humidification of the cathodes of the multiple fuel cells 3 evaluated based on the determined starting parameter. In the case that the humidification of the cathodes of the multiple fuel cells 3 is too low, a control parameter for readjusting the humidifier is determined in step C and a control variable readjusted according to the control parameter. In the step D, a diagnostic parameter is then determined and the degradation of the humidifier 4 established based on the diagnostic parameter.

In the steps A-C of the method 5, the humidifier 4 is readjusted and because of this the lacking humidification of the cathodes of the fuel cells 3 compensated for based on the progressive ageing of the humidifier 4. In the step D of the method 5 it is established if the lacking humidification of the cathodes of the fuel cells 3 can no longer be compensated by readjusting the humidifier 4. From this it is finally concluded when the humidifier 4 has to be replaced.

In the following, the method 5 is explained in more detail by way of exemplary embodiments. It is to be understood that these exemplary embodiments do not restrict the invention and merely serve for a better understanding.

In the one exemplary embodiment the fuel cell system 1 includes the humidifier 4, which is designed for low load points of the fuel cells 3 or of the fuel cell stack 2. In addition, the fuel cell system 1 includes on the inlet side and on the dry side of the humidifier 4, a bypass having a controllable bypass valve. During the operation of the fuel cells 3 or of the fuel cell stack 2, the water volume on the cathodes of the fuel cells 3 can be reduced by a bypass that is opened to a greater degree or by the bypass valve that is opened to a greater degree. During the operation of the fuel cells 3 or of the fuel cell stack 2, the water volume through the bypass that is closed to a greater degree or the bypass valve that is closed to a greater degree, the water volume on the cathodes of the fuel cells 2 can be increased. In other words, the water volume on the cathodes of the fuel cells 3 or the humidification of the cathodes of the fuel cells 3 can be adjusted by an opening/closing position of the bypass valve of the bypass.

In the method 5, the relative humidity of the fuel cell stack 2—here the starting parameter—can then be measured in the step A on the inlet side on the fuel cell stack 2. In the step B it can then be evaluated if the relative humidity of the fuel cell stack 2 and because of this the humidification of the cathodes 3 is adequate. In the case that the humidification of the cathodes of the fuel cells 3 is too low, the closing and opening position of the bypass valve necessary for increasing the humidification of the cathodes—here the control parameter—can be determined. Following this, a degree of flow through the bypass—here the control variable—can be suitably adapted by changing the current closing/opening position of the bypass valve to the closing/opening position of the bypass valve determined in step C. In step D it can then be determined if the voltage in a voltage/current characteristic of the battery cell stack 2—here the diagnostic parameter—corresponds to an expected voltage after the change of the closing/opening position of the bypass valve in the step C or not.

In the second exemplary embodiment, the fuel cell system 1 is constructed identically to the fuel cell system 1 in the first exemplary embodiment. The bypass valve on the bypass however can be regulated.

The steps A-C of the method 5 in the fuel cell system 1 according to the first exemplary embodiment and according to the second exemplary embodiment are identical. In the step D, deviating from the first exemplary embodiment, a temporal change of the closing/opening position of the bypass valve—here the diagnostic parameter—is determined. The temporal change is considered over the lifespan of the humidifier 4 compared with a predefined control characteristic map of the bypass valve and based on that, the degradation of the humidifier 4 is concluded.

In the third exemplary embodiment, the fuel cell system 1 includes the humidifier 4, which is under-dimensioned for lower load points of the fuel cells 3 or of the fuel cell stack 2 and primarily designed for high load points of the fuel cells 3 or of the fuel cell stack 2. In the third exemplary embodiment, the fuel cell system 1 can also have no bypass with the bypass valve. By contrast, the fuel cell system 1 comprises a cooling system for cooling the fuel cell stack 2. The cooling system can be flowed through by a cooling liquid and includes a heat exchanger and/or a blower for cooling the cooling liquid.

The steps A-B and D of the method 5 in the fuel cell system 1 according to the first exemplary embodiment and according to the third exemplary embodiment are identical. In the case that in the step B the insufficient humidification of the cathodes of the fuel cells 3 is established, the cooling capacity of the cooling system—here the control variable—is, distinctly, increased in the step C by a lowering of the temperature of the cooling liquid—here the control parameter. For this purpose, the flow through the heat exchanger and/or the rotational speed of the blower can be increased. The flow through the heat exchanger can be carried out for example by opening to a greater degree one of the valves leading to the heat exchanger.

1. A method for establishing a degradation of a humidifier of a fuel cell system, the fuel cell system including at least one fuel cell stack having multiple fuel cells each with a cathode and an anode and the humidifier for humidifying the cathodes of the multiple fuel cells, the method comprising:
in a step A, determining a starting parameter of the fuel cell stack;
in a step B, based on the determined starting parameter, evaluating a humidification of the cathodes of the multiple fuel cells;
in a step C, in the case that the humidification of the cathodes of the multiple fuel cells is too low, determining a control parameter for readjusting the humidification and readjusting a control variable according to the control parameter;
in a step D, determining a diagnostic parameter and based on the diagnostic parameter the degradation of the humidifier is established.

2. The method according to claim 1, wherein the starting parameter determined in the step A is a relative humidity of a gas flowing to the cathodes of the fuel cell stack, which is measured on an inlet side on the fuel cell stack.

3. The method according to claim 1, wherein:
the fuel cell system further includes a cooling system that can be flowed through by a cooling liquid for cooling the fuel cell stack, and
the control parameter for readjusting the humidification determined in the step C is specified by a temperature of the cooling liquid that is re-adjustable via the cooling system.

4. The method according to claim 3, wherein:
the cooling system further includes a heat exchanger and/or a blower for cooling the cooling liquid; and
in the step C for readjusting the humidification, the cooling capacity of the cooling system is increased by readjusting the flow through the heat exchanger and/or by readjusting the blower.

5. The method according to claim 1, wherein:
the humidifier on an inlet side and on a dry air side comprises a bypass having a bypass valve for flowing past the humidifier; and
the control parameter for readjusting the humidification determined in the step C is specified by a closing/opening position of the bypass valve of the bypass.

6. The method according to claim 5, wherein:
the diagnostic parameter determined in the step D is specified by a temporal change of the closing/opening position of the bypass valve over the lifespan of the humidifier compared with a predefined control characteristic map of the bypass valve; and
the degradation of the humidifier is established based on the determined temporal change of the closing/opening position of the bypass valve.

7. The method according to claim 1, wherein the diagnostic parameter determined in the step D is specified by a change of a voltage in a voltage/current characteristic of the fuel cell stack during the readjusting of the control variable in the step C.

8. The method according to claim 7, wherein when establishing the degradation, the voltages before and after the readjusting of the control variable in the step C are compared with one another, wherein upon a rise of the measured voltage after the readjusting of the control variable in the step C, at least at one specified current value of the voltage/current characteristic, the degradation of the humidifier is evaluated.

9. The method according to claim 7, wherein:
the voltage is determined via a terminal voltage measurement on the fuel cell stack; or
the voltage is read from an integrated control unit of the fuel cell stack.

10. The method according to claim 7, wherein at least one of:
when determining the voltage, a run-up to specified stationary operating point of the fuel cell system is carried out;
when establishing the degradation, an existent degradation model of the fuel cell stack is taken into account; and/or
before determining the voltage, a specified O2/O2, condition of anodes and cathodes of the fuel cells of the fuel cell stack is ensured; and
before determining the voltage, a specified H2/H2 condition on anodes and cathodes of the fuel cells of the fuel cell stack is ensured.

11. The fuel cell system comprising:
at least one fuel cell stack with multiple fuel cells, each fuel cell with a cathode and an anode,
a humidifier for humidifying the cathodes of the multiple fuel cells;
wherein the fuel cell system is configured for carrying out the method according to claim 1.

12. The method according to claim 1, wherein the steps A, B, C, D are consecutively carried out.

13. A method for establishing a degradation of a humidifier of a fuel cell system, comprising:
in a step A, determining a starting parameter of a fuel cell stack, the fuel cell stack including multiple fuel cells each with a cathode and an anode;
in a step B, based on the determined starting parameter, evaluating a humidification of the cathodes of the multiple fuel cells;
in a step C, in the case that the humidification of the cathodes of the multiple fuel cells is too low, determining a control parameter for readjusting the humidification and readjusting a control variable according to the control parameter;
in a step D, determining a diagnostic parameter and based on the diagnostic parameter the degradation of the humidifier is established.

14. The method according to claim 13, wherein:
the humidifier on an inlet side and on a dry air side comprises a bypass having a bypass valve for flowing past the humidifier;
the control parameter for readjusting the humidification determined in the step C is specified by a closing/opening position of the bypass valve of the bypass.

15. The method according to claim 14, wherein:
the voltage is determined via a terminal voltage measurement on the fuel cell stack; or
the voltage is read from an integrated control unit of the fuel cell stack.

16. The method according to claim 15, wherein when determining the voltage, a run-up to specified stationary operating point of the fuel cell system is carried out.

17. The method according to claim 15, wherein when establishing the degradation, an existent degradation model of the fuel cell stack is taken into account.

18. The method according to claim 15, wherein before determining the voltage, a specified O2/O2, condition of anodes and cathodes of the fuel cells of the fuel cell stack is ensured.

19. The method according to claim 15, wherein before determining the voltage, a specified H2/H2 condition on anodes and cathodes of the fuel cells of the fuel cell stack is ensured.

20. The method according to claim 13, wherein the starting parameter determined in the step A is a relative humidity of a gas flowing to the cathodes of the fuel cell stack, which is measured on an inlet side on the fuel cell stack.
